(19) United States
(12) Patent Application Publication
(10) Pub. No.: US 2022/0227443 A1
(43) Pub. Date: Jul. 21, 2022

(54) RESILIENT MOTORCYCLE FOOT PEG

(71) Applicant: JEFFERY L. VESSELLO, CHARLTON, MA (US)

(72) Inventor: JEFFERY L. VESSELLO, CHARLTON, MA (US)

(21) Appl. No.: 17/405,355

(22) Filed: Aug. 18, 2021

Related U.S. Application Data
(60) Provisional application No. 63/067,140, filed on Aug. 18, 2020.

(51) Int. Cl. B62J 25/06

(52) U.S. Cl. CPC B62J 25/06

(57) ABSTRACT

A motorcycle foot peg is pivoted to the motorcycle frame and a resilient bump stop element is provided that absorbs shock force to a rider during operation of the motorcycle.

### BACKGROUND OF THE INVENTION

Motorcycles (hereinafter understood as both motored and non-motored) normally have two pegs on which the rider places his/her (hereinafter his) feet. The pegs are normally rigidly attached directly to the frame of the motorcycle.

Physical shocks generated between the ground and the motorcycle are transmitted to the rider through the motorcycle frame, and, through the ridged pegs, to the rider's feet. This shock can cause discomfort and injury to the rider.

It is the primary object of this invention to minimize the shock conveyed to the motorcycle rider and thereby minimize potential discomfort and injury experience by the rider.

### BRIEF SUMMARY OF THE INVENTION

This invention involves pivotally mounting the pegs to the motorcycle, and positioning a resilient bump stop element between the pedal and the motorcycle, in such a manner that the shock from the ground is absorbed by the resilient bump stop element and is not transferred to the rider's feet.

In one embodiment of this invention, each pivotally mounted foot peg lies in a generally horizontal aspect with a horizontal resilient bump stop element situated between the peg and the motorcycle frame, below the pivot point of the peg, such that, when a downward force is applied to the peg the horizontal bump stop element compresses towards and against the motorcycle frame and adsorbs the shock from the ground so that the shock from the ground is not transferred to the rider's feet.

In another embodiment of this invention, each pivotally mounted foot peg lies in a generally horizontal aspect with a vertical resilient bump stop element, the bump stop upwardly facing, situated between the peg and an extended portion of the motorcycle frame, beyond the pivot point of the peg, such that, when a downward force is applied to the peg the vertical bump stop element compresses upwards and against a portion of the motorcycle frame and adsorbs the shock from the ground so that the shock from the ground is not transferred to the rider's feet.

### BRIEF DESCRIPTION OF THE SEVERAL VIEWS OF THE DRAWING

FIG. 1—A rear view of peg showing the uncompressed bump stop resilient material in horizontal contact with the motorcycle frame

FIG. 2—A rear view of peg showing the bump stop resilient material under compression in horizontal contact with the motorcycle frame

FIG. 3—A rear view of the peg

FIG. 4—A top view of the peg

FIG. 5—A side view of the peg

FIG. 6—A rear view of peg showing the uncompressed bump stop resilient material in vertical contact with a portion of the motorcycle frame

FIG. 7—A rear view of peg showing the bump stop resilient material under compression in vertical contact with a portion of the motorcycle frame

FIG. 8—A rear view of the peg showing the bump stop resilient material in vertical position

FIG. 9—A top view of the peg

FIG. 10—A side view of the peg

FIG. 11 is a top plan view of a resilient bushing that embodies the principles of the present invention.

FIG. 12 is an elevation view which shows all four identical sides of a resilient bushing that embodies the principles of the present invention.

### DETAILED DESCRIPTION OF THE INVENTION

In one embodiment the peg is pivotally mounted to the motorcycle frame, connected to the motorcycle frame by means of a rod and bushing. This allows for slight pivotal movement of the peg about the axis of the rod.

A resilient bump stop element is positioned between the pedal and the motorcycle frame, horizontally, at the lower part of the frame-facing side of the peg, such that, without a load on the peg the resilient bump stop element keeps the peg in the peg's resting horizontal position while the bump stop remains uncompressed between the peg and the motorcycle frame.

During the operation of the motorcycle, when a downward force (shock) is applied to the peg, for example when the motorcycle is rattled by a bumpy road (causing the weight and inertia of the operator to be forced downward on the peg), the force pivots the peg about the rod and bushing connection, and the leverage force of the rotating peg is re-directed towards the motorcycle frame through the resilient bump stop element. The resilient bump stop element is thereby compressed along the line of the re-directed force, absorbing the shock and minimizing the potential discomfort and injury experienced by the operator.

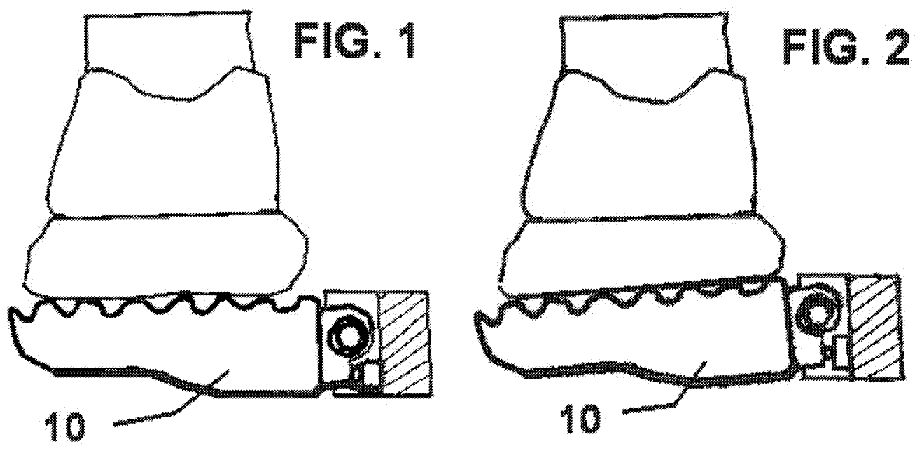

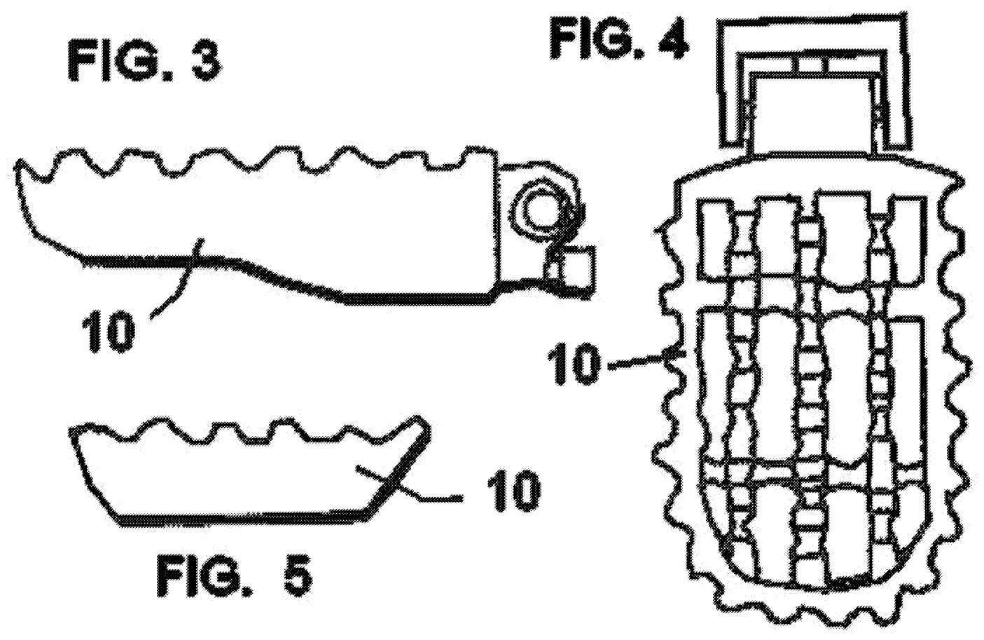

One embodiment of this invention, as shown in FIGS. 1-5, has each foot peg resting pivotally on a horizontally aligned resilient bump stop element that acts to adsorb the shock. Again, minimizing the potential discomfort and injury experienced by the operator. This is also illustrated in the separate drawings with notations.

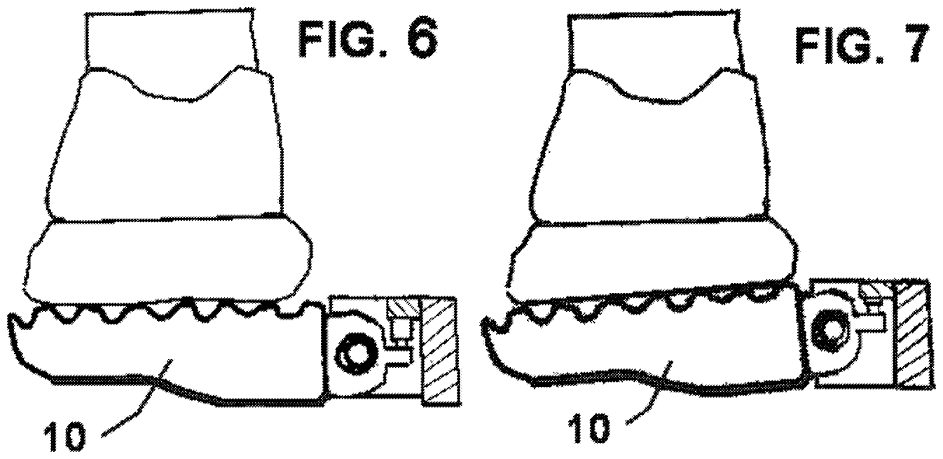

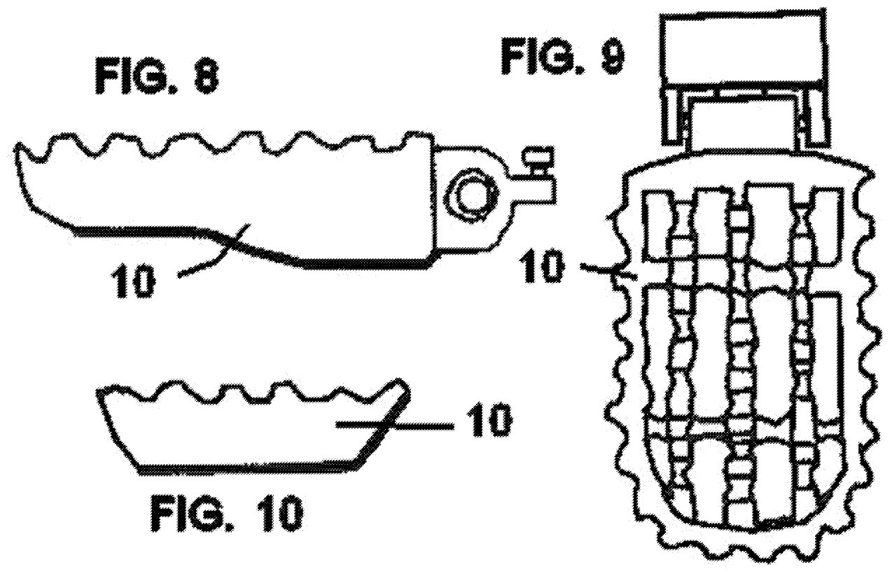

Another embodiment of this invention, as shown in FIGS. 6-10, has each foot peg resting pivotally on a vertically aligned resilient bump stop element that acts to adsorb the shock. Again, minimizing the potential discomfort and injury experienced by the operator. This is also illustrated in the separate drawings with notations.

FIGS. 1-10 show views, including a possible placement of resilient encased rubber bushings in the design of the peg, and an adjustable rubber bump stop (representing any appropriate resilient material). Also included is an image of outer cleats situated at an angle which provides sturdy traction when the rider leans back or forward. Furthermore, the images show some possible configurations of a typical peg.

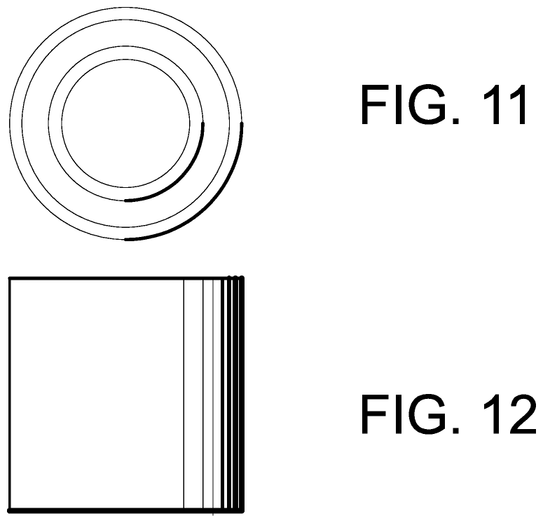

FIGS. 11 and 12 show a representation of one possible example of a bushing having rubber material integrated in its design.

1. A motorcycle foot peg pivotally connected to a motorcycle frame having a bump stop made of a resilient material situated between the peg and the frame absorbing shock forces that would otherwise be transmitted to the operator of the motorcycle.

2. A motorcycle foot peg as recited in claim 1, wherein the bump stop moves horizontally.

3. A motorcycle foot peg as recited in claim 1, wherein the bump stop moves vertically.

4. A motorcycle foot peg as recited in claim 1, wherein the bump stop moves diagonally.

5. A motorcycle foot peg as recited in claim 1, wherein the foot peg includes a pedal having upward and outward extending spikes that increase the friction between the pedal and the rider's foot.

6. A motorcycle foot peg pivotally connected, by an axle, to a motorcycle frame having a bump stop made of a resilient material situated between the peg and the frame absorbing shock forces that would otherwise be transmitted to the operator of the motorcycle.

7. A motorcycle foot peg, pivotally connected, by an axle, to a motorcycle frame having a bump stop made of a resilient material situated between the peg and the frame absorbing shock forces that would otherwise be transmitted to the operator of the motorcycle, wherein said axial is held in a resilient bushing.

8. A motorcycle foot peg as recited in claim 7, wherein the resilient bushing is formed of two concentric rigid tubes with resilient material between the tubes.
